(19) United States
(12) Patent Application Publication
(10) Pub. No.: US 2017/0147202 A1
(43) Pub. Date: May 25, 2017

(54) AUGMENTING TEXT MESSAGES WITH EMOTION INFORMATION

(71) Applicant: Facebook, Inc., Menlo Park, CA (US)

(72) Inventor: Aran Donohue, Menlo Park, CA (US)

(21) Appl. No.: 14/950,986

(22) Filed: Nov. 24, 2015

(51) Int. Cl. G06F 3/0488; G06F 17/21; G06F 3/0481

(52) U.S. Cl. CPC G06F 3/04886; G06F 3/04817; G06F 17/214

(57) ABSTRACT

The present disclosure relates to systems, methods, and devices for augmenting text messages. In particular, the message system augments text messages with emotion information of a user based on characteristics of a keyboard input from the user. For example, one or more implementations involve predicting an emotion of the user based on the characteristics of the keyboard input for a message. One or more embodiments of the message system select a formatting for the text of the message based on the predicted emotion and format the message within a messaging application in accordance with the selected formatting.

### BACKGROUND

1. Technical Field

One or more embodiments described herein relate generally to systems and methods for augmenting electronic messages based on context information. More specifically, one or more embodiments relate to systems and methods of augmenting text messages with emotion information associated with senders of the messages.

2. Background and Relevant Art

The use of electronic devices with frequent access to the Internet increases the ability for users to communicate with each other. Electronic messaging systems allow users to communicate with each other using one or more different types of communication media, such as text, emoticons, icons, images, video, and/or audio. Using such electronic methods, many electronic messaging systems allow users to communicate quickly with other users.

Electronic messaging systems that include the ability to send text messages allow a sender to communicate with other users without requiring the sender to be immediately available to respond. For example, instant messaging, SMS messaging, and similar communication methods allow a user to quickly send a text message to another user that the recipient can view at any time after receiving the message. Additionally, electronic messaging systems that allow users to send messages including primarily text also use less network bandwidth and storage resources than other types of communication methods.

Conventional electronic communication systems, however, often include limitations that result in very brief messages that may not convey everything that the sender wishes to or is able to convey by way of text or icons available to the sender. Specifically, electronic messaging systems that allow users to send and receive messages that contain primarily text/icons are often unable to communicate certain emotional or contextual information that more accurately describes the intended meaning of the messages. For example, messages containing only text may lose emotional context associated with an intended meaning or a current mood of the sender. Because emotional and other context can greatly affect the meaning of text-based messages, recipients of the messages may not be able to easily and accurately interpret the intended meanings based solely on the text, potentially resulting in misunderstandings between senders and recipients.

Accordingly, there are a number of disadvantages with conventional electronic communication systems and methods.

### SUMMARY

One or more embodiments described herein provide benefits and/or solve one or more of the foregoing or other problems in the art with systems and methods to augment text messages with emotion information associated with senders. In particular, one or more embodiments associate emotion information with a message based on characteristics of an input from the user in connection with the message. For example, the disclosed systems and methods can display a message in a way that indicates a predicted emotion in connection with the characteristics of the input from the user. Thus, the systems and methods can display text in a message in a way that depicts a predicted emotion of the sender, thereby allowing a recipient of the message to more accurately interpret the message in light of the emotions of the sender.

Additionally, to display the message with the emotion information, the systems and methods can format the text in the message according to the predicted emotion of the sender. Specifically, the systems and methods can convey a specific emotion of the sender simply and effectively by formatting the text of a message based on the identified characteristics of the input. For example, one or more embodiments select a formatting for the text of the message based on the predicted emotion and format the message according to the selected formatting. Thus, the systems and methods can convey different emotions with the same text by using different text formats within a messaging application.

Additional features and advantages of the embodiments will be set forth in the description that follows, and in part will be obvious from the description, or can be learned by the practice of such exemplary embodiments. The features and advantages of such embodiments can be realized and obtained by means of the instruments and combinations particularly pointed out in the appended claims. These and other features will become more fully apparent from the following description and appended claims, or can be learned by the practice of such exemplary embodiments as set forth hereinafter.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. In the following drawings, bracketed text and blocks with dashed borders (e.g., large dashes, small dashes, dot-dash, dots) are used herein to illustrate optional features or operations that add additional features to embodiments of the disclosure. Such notation, however, should not be taken to mean that these are the only options or optional operations, and/or that blocks with solid borders are not optional in certain embodiments of the disclosure. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates a schematic diagram of an example system that facilitates electronic communications in accordance with one or more embodiments;

FIG. 2 illustrates a detailed schematic diagram of a client device in the system of FIG. 1 in accordance with one or more embodiments;

FIGS. 3A-3F illustrate user interfaces for exchanging messages in accordance with one or more embodiments;

FIG. 4 illustrates a flow chart of a series of acts in a method of augmenting text messages in accordance with one or more embodiments;

FIG. 5 illustrates a block diagram of an example computing device in accordance with one or more embodiments;

FIG. 6 illustrates an example network environment of a social-networking system in accordance with one or more embodiments; and

FIG. 7 illustrates an example social graph for a social-networking system in accordance with one or more embodiments.

### DETAILED DESCRIPTION

Embodiments of the present disclosure provide a message system that improves the ability for users to interpret text messages. In particular, in accordance with one or more embodiments disclosed herein, a message system augments text messages with emotion information that allows recipients of the text messages in a messaging application to infer a mood, emotion, or other context of senders in connection with the text messages. For example, the message system can identify context information associated with input from a sender in connection with a message containing text, such as one or more characteristics of the input from the sender. The one or more characteristics allow the message system to predict an emotion of the sender in connection with the message. The message system can then select a formatting for the text in the message to communicate the predicted emotion in the message to a recipient of the message.

By integrating emotion information within a text message (e.g., by formatting the text of the text message to reflect the emotion information), the message system can retain context associated with the message that might otherwise be lost in a conventional text message. Thus, the message system can allow recipients of messages to infer emotions of the sender based on, for example, the formatting of the text in a message from the sender. Automatically formatting the text in a message to convey emotion information allows the sender to more accurately convey a specific meaning of the message without requiring that the sender include other content or explicitly state an emotion in the text.

Providing emotion information by formatting text in a message can also allow senders to convey different messages using the same text. Specifically, text can have different intended meanings based on emotions of the sender in connection with the text. Applying different formatting to the text in a message can change the way a recipient interprets the message. By determining how to format a message based on certain characteristics or cues associated with the input from the sender, the message system can display the message so that the recipient is more likely to correctly interpret the intended meaning of the message.

In one or more embodiments, the message system can use information from a client device of a sender to identify characteristics of the keyboard input. For example, the message system can capture data from a keyboard of the client device and/or one or more sensors of the client device. The message system can analyze the data from the keyboard and/or sensors to identify characteristics of an input in connection with a message of a messaging application. The message system can identify the characteristics to determine contextual information (e.g., emotion information) that can be provided to a recipient of the message in conjunction with text of the message.

The identified characteristics can provide insight into what the sender is doing or how the sender is feeling at the time of composing the message. In particular, the message system to predict an emotion that likely corresponds to the identified characteristics. For example, the message system can determine that a given keyboard input characteristic is indicative of a particular emotion. The message system can then assign the particular emotion to the message based on the given characteristic to add context information to the message.

Additionally, one or more embodiments of the message system can assign the emotion to the message by modifying an appearance of the text in the message. In particular, the message system can select a formatting for the text in the message based on the predicted emotion assigned to the message. Varying the formatting of text in messages can allow recipients to correctly interpret emotions of senders associated with the text for better understanding intended meanings of the messages.

As used herein, the term “text message” refers to an electronic message that includes text. For example, a text message can include an electronic message sent using a messaging application on a client device that allows two or more users to communicate (e.g., via a message system or service) with each other with text and/or other content (e.g., images). To illustrate, a text message can include an instant message, an SMS message, an email message, a social network post, or other method of communication that includes text.

As used herein, the term “predicted emotion” refers to an emotion, mood or status that the message system predicts, infers, and/or associates with a user. Specifically, the message system can predict an emotion, mood, or status of a user based on various characteristics associated with a message and/or the user. To illustrate, a predicted emotion can include an emotion that is mapped to one or more characteristics of text input. For example, the mapping of emotions to characteristics can be based on research indicating tendencies of users (e.g., for inputting text) when experiencing certain emotions, as will be explained in more detail below.

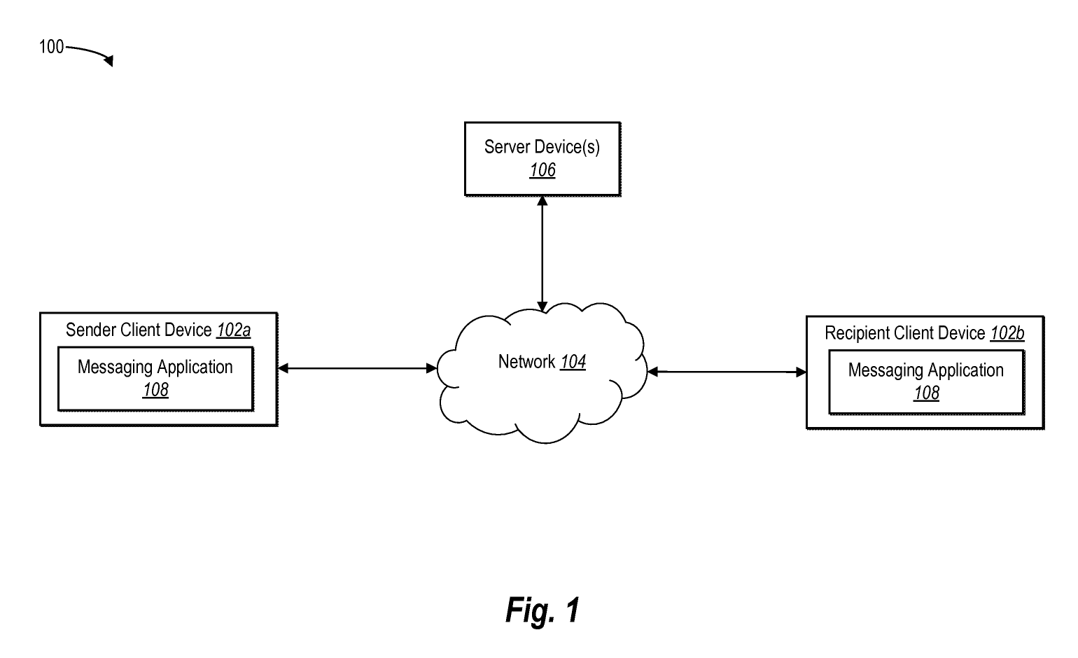

FIG. 1 is a schematic diagram illustrating a message system 100 in accordance with one or more embodiments. An overview of the message system 100 is described in relation to FIG. 1. Thereafter, a more detailed description of the components and processes of the message system 100 is provided in relation to the remaining figures.

As illustrated by FIG. 1, the message system 100 allows a sender and a recipient to communicate with each other using a sender client device 102a and a recipient client device 102b (collectively “client devices 102”), respectively. Although not shown, the message system 100 may include any number of additional users and corresponding client devices. As further illustrated in FIG. 1, the client devices 102a, 102b can communicate with each other via a network 104. Additionally, the message system 100 can include server device(s) 106 accessible via the network 104. Although FIG. 1 illustrates a particular arrangement of the client devices, the network 104, and the server device(s) 106, various alternative arrangements are possible. For example, the client devices may directly communicate with each other and/or with the server device(s) 106, bypassing the network 104. Furthermore, although FIG. 1 is described in relation to sending a text message from the sender client device 102a to the recipient client device 102b, the sender client device 102a can also receive messages from other client devices, and the recipient client device 102b can also send messages to other client devices.

As briefly mentioned above, the sender and the recipient can use the sender client device 102a and the recipient client device 102b, respectively, to communicate with one another via the server device(s) 106. For example, the sender can send an electronic message containing text to the recipient according to one or more messaging formats (e.g., via a social networking system operating on the server device(s) 106). For instance, the sender, using the sender client device 102a, can compose a message intended for the recipient. After composing the message, the sender can cause the sender client device 102a to send the message intended for the recipient via the network 104 to the server device(s) 106. The server device(s) 106 can identify the recipient as the intended recipient and forward the message to the recipient client device 102b associated with the recipient.

The users of client devices 102 can be individual people. Additionally or alternatively, the user may include other entities, such as business, government, or other entities. For example, the sender can use the message system 100 to send text messages to a business in connection with a purchase of services or products. Similarly, the sender can use the message system 100 to send a text message to a plurality of recipients within the messaging application 108, including different groups of users (e.g., a mix of people and entities).

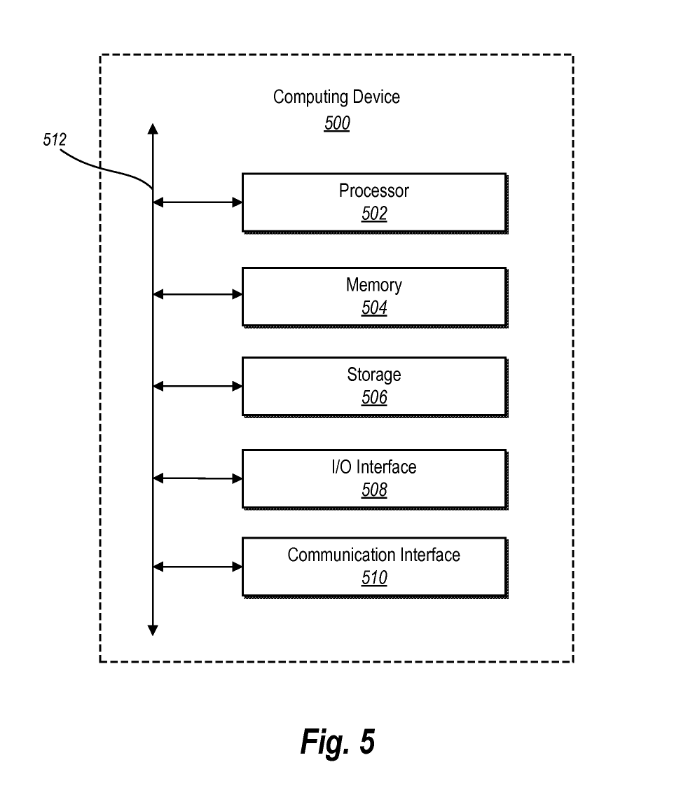

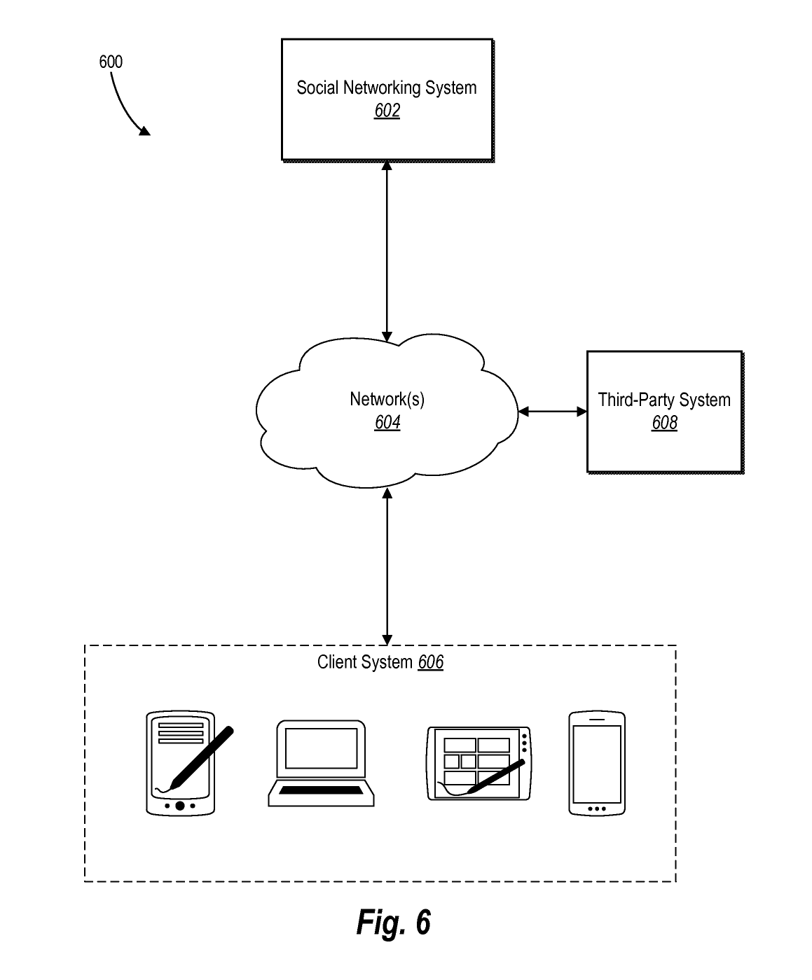

As mentioned above, and as FIG. 1 illustrates, the sender and the recipient can interact with the sender client device 102a and the recipient client device 102b, respectively. Examples of the client devices 102 include computing devices such as mobile devices (e.g., smartphones, tablets), laptops, desktops, or any other type of computing device. FIG. 5 and the corresponding description provide additional information regarding computing devices that can represent client devices 102a. Moreover, and as mentioned above, the client devices 102 can communicate with each other and with the server device(s) 106 through the network 104. In one or more embodiments, the network 104 includes the Internet or World Wide Web. The network 104, however, can include one or more private and/or public networks that use various communication technologies and protocols, as further described below with reference to FIGS. 5-6.

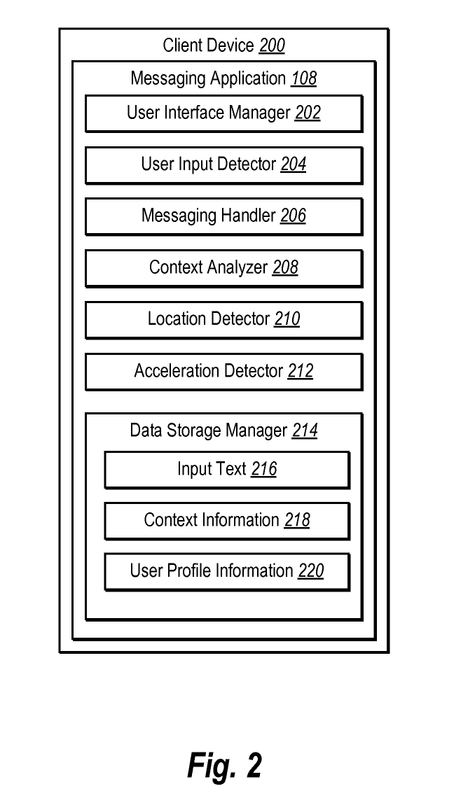

FIG. 2 illustrates a schematic diagram of a client device 200 in the message system 100 of FIG. 1 in accordance with one or more embodiments of the present disclosure. Specifically, the client device 200 of FIG. 2 can represent the sender client device 102a or the recipient client device 102b of FIG. 1. The client device 200 can send messages to and/or receive messages from other client devices within the message system 100. Additionally, the client device 200 can communicate with the server device(s) 106 within the message system 100.

As shown, the message system 100 can include various components on the client device 200. For example, FIG. 2 illustrates that the client device 200 can include a messaging application 108 with various components to allow users to send and receive messages as described in greater detail below. Although FIG. 2 illustrates various components of the messaging application 108 on the client device 200, the message system 100 may include one or more of the illustrated components on the server device(s) 106 or on another device within the message system 100. For example, one or more of the components of the messaging application 108 may reside on the server device(s) 106 and may be capable of performing operations described herein for more than one client device 200.

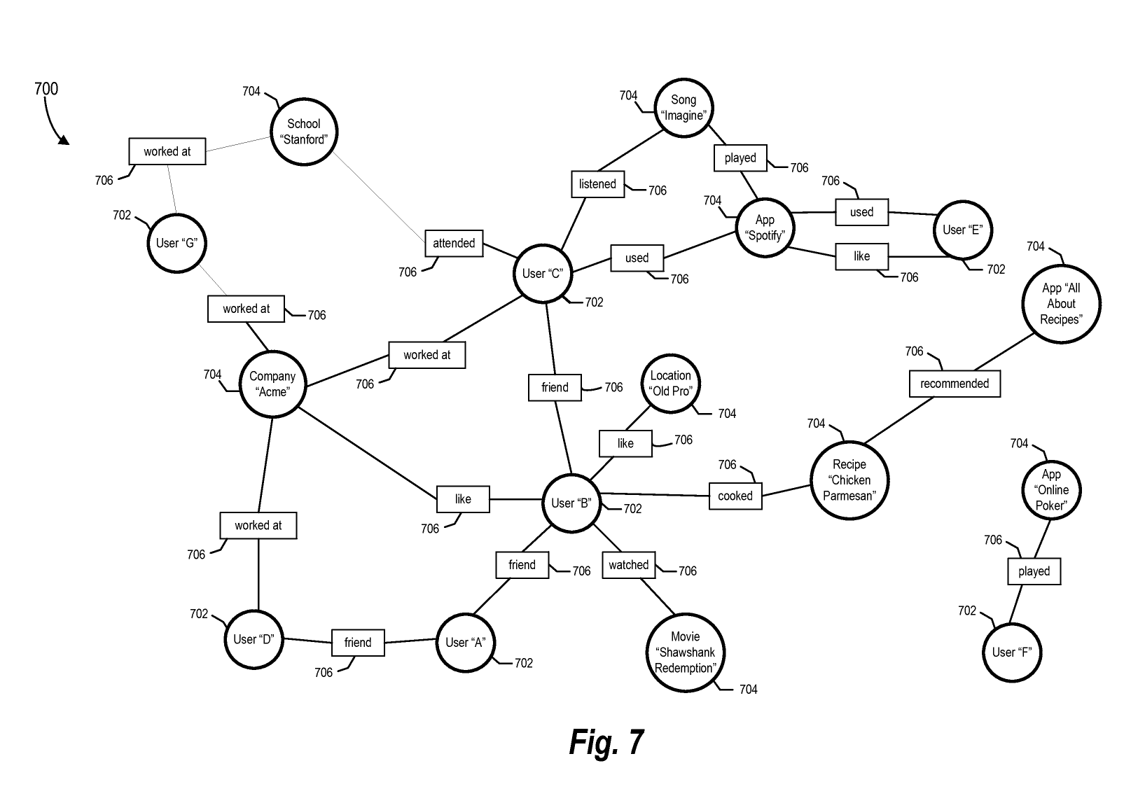

As shown, the messaging application 108 includes a user interface manager 202, a user input detector 204, a messaging handler 206, a context analyzer 208, a location detector 210, an acceleration detector 212, and a data storage manager 214. Each of the components can communicate with each other using any suitable technologies. It will be recognized that although the components are shown to be separate in FIG. 2, any of the components may be combined into fewer components, such as into a single component, or divided into more components as may serve a particular embodiment. Additionally, one or more of the components may be part of another application or component separate from the messaging application 108 on the client device 200. In one or more embodiments in which a user of the client device 200 communicates with another user via a social-networking system on the server device(s) 106, the components may have access to a social graph, as described in more detail below with reference to FIG. 7.

The components can include software, hardware, or both. For example, the components can include computer instructions stored on a non-transitory computer-readable storage medium and executable by at least one processor of the client device 200. When executed by the at least one processor, the computer-executable instructions can cause the client device 200 to perform the methods and processes described herein. Alternatively, the components can include hardware, such as a special purpose processing device to perform a certain function or group of functions. Additionally or alternatively, the components can include a combination of computer-executable instructions and hardware.

In one or more embodiments, the messaging application 108 can be a native application installed on the client device 200. For example, the messaging application 108 may be a mobile application that installs and runs on a mobile device, such as a smartphone or a tablet. Alternatively, the messaging application 108 can be a desktop application, widget, or other form of a native computer program. Alternatively, the messaging application 108 may be a remote application that the client device 200 accesses. For example, the messaging application 108 may be a web application that executes within a web browser of the client device 200.

As mentioned above, and as shown in FIG. 2, the messaging application 108 can include a user interface manager 202. The user interface manager 202 can provide, manage, and/or control a graphical user interface (or simply “user interface”) that allows a user to compose, view, and send messages. For example, the user interface manager 202 can provide a user interface that facilitates the composition of a message, such as an instant message. Likewise, the user interface manager 202 can provide a user interface that displays messages received from other users.

More specifically, the user interface manager 202 may facilitate the display of a user interface (e.g., by way of a display device associated with the client device 200). For example, the user interface may be composed of a plurality of graphical components, objects, and/or elements that allow a user to compose, view, send and/or receive messages. More particularly, the user interface manager 202 may direct the client device 200 to display a group of graphical components, objects and/or elements that enable a user to view a messaging thread.

In addition, the user interface manager 202 may direct the client device 200 to display a one or more graphical objects or elements that facilitate user input for composing and sending a message. To illustrate, the user interface manager 202 may provide a user interface that allows a user to provide user input to the messaging application 108. For example the user interface manager 202 can provide one or more user interfaces that allow a user to input one or more types of content into a message. As used herein, “content” refers to any data or information to be included as part of a message. For example, the term “content” will be used herein to generally describe, text, images, digital media, files, location information, payment information and any other data that can be included as part of a message.

Although the messaging application 108 is capable of sending any type of message content described herein, the present disclosure specifically relates to augmenting text content in messages of the messaging application 108. In one or more embodiments, the user interface manager 202 can provide a user interface to allow a user to easily and efficiently send messages containing text to one or more other users. For example, the user interface manager 202 can provide one or more input fields and/or one or more selectable elements with which a user can interact to create and send a text message and/or interact with the messaging application 108.

In addition to the foregoing, the user interface manager 202 can receive instructions or communications from one or more components of the messaging application 108 to display updated message information and/or updated available actions. The user interface manager 202 can update an available option based on whether a particular option is available at a particular point within a messaging process. The user interface manager 202 can add, remove, and/or update various other selectable options within the sender and/or receiver status messages, as will be discussed below.

The user interface manager 202 can facilitate the input of text or other data to be included in an electronic communication or message. For example, the user interface manager 202 can provide a user interface that includes a keyboard. A user can interact with the keyboard using one or more touch gestures to select text to be included in an electronic communication. In some embodiments, the electronic communication can include text and nothing else. In additional embodiments, a user can use the keyboard to enter a message to accompany and/or describe one or more other content items in an electronic communication. In addition to text, the user interface, including the keyboard interface, can facilitate the input of various other characters, symbols, icons, or other character information.

As further illustrated in FIG. 2, the messaging application 108 can include a user input detector 204. In one or more embodiments, the user input detector 204 can detect, receive, and/or facilitate user input in any suitable manner. In some examples, the user input detector 204 can detect one or more user interactions with respect to the user interface. As referred to herein, a “user interaction” refers to a single interaction, or combination of interactions, received from a user by way of one or more input devices.

For example, user input detector 204 can detect a user interaction from a keyboard, mouse, touch pad, touchscreen, and/or any other input device. In the event the client device 200 includes a touchscreen, the user input detector 204 can detect one or more touch gestures (e.g., swipe gestures, tap gestures, pinch gestures, or reverse pinch gestures) from a user that forms a user interaction. In some examples, a user can provide the touch gestures in relation to and/or directed at one or more graphical objects or graphical elements of a user interface.

The user input detector 204 may additionally, or alternatively, receive data representative of a user interaction. For example, user input detector 204 may receive one or more user configurable parameters from a user, one or more user commands from the user, and/or any other suitable user input. The user input detector 204 may receive input data from one or more components of the messaging application 108, from the storage on the client device 200 or from one or more remote locations (e.g., the server device(s) 106).

The messaging application 108 can perform one or more functions in response to the user input detector 204 detecting user input and/or receiving other data. Generally, a user can control, navigate within, and otherwise use the messaging application 108 by providing one or more user inputs that the user input detector 204 can detect. For example, in response to the user input detector 204 detecting user input, one or more components of the messaging application 108 allow a user to select a recipient for a message, compose a message, select content to include in a message, and/or send a message to the recipient. In addition, in response to the user input detector 204 detecting user input, one or more components of the messaging application 108 allow a user to navigate through one or more user interfaces to review received messages, contacts, etc.

As further illustrated in FIG. 2, the messaging application 108 can include a messaging handler 206 that manages messages provided to or sent from the messaging application 108. For example, the messaging handler 206 can interact with the user interface manager 202 and the user input detector 204 to coordinate the sending and receiving of messages using the messaging application 108. The messaging handler 206 may direct the sending and receiving of messages to and from the server device(s) 106 over the course of an electronic messaging session among a plurality of participants. The messaging handler 206 may organize incoming and outgoing messages and direct the user interface manager 202 to display messages.

In one or more embodiments, the messaging handler 206 can facilitate receiving and sending data via the messaging application 108. In particular, messaging handler 206 can facilitate sending and receiving messages. For example, the messaging handler 206 can package content to be included in a message and format the message in any necessary form that is able to be sent through one or more communication channels and using an appropriate communication protocol, as described herein. Likewise, the messaging handler 206 can process messages the client device 200 receives from other users.

In addition to providing communication functions for the messaging application 108, the messaging handler 206 can provide access to message data. For example, the messaging handler 206 can access data that represents a list of contacts, or one or more groups of contacts, to include as recipients of a message. To illustrate, the messaging handler 206 can obtain and provide data representing a contact list to the user interface manager 202 to allow the user to search and browse a contact list, and ultimately select an individual contact or group of contacts to include as recipients of a message. In one or more embodiments, a social-networking system can maintain remote contact list data (e.g., a “friends list”), and the messaging handler 206 can access the contact list data on the social-networking system for use within the messaging application 108.

The messaging handler 206 can also provide access to other local or remote data that the messaging application 108 can use to compose, send and receive messages. For instance, the messaging handler 206 can obtain access to files, images, audio, video and other content that a user can include in a message. Moreover, the messaging handler 206 can provide access to one or more functions of the client device 200 to provide the user the ability to capture or create content to include within a message. For example, the messaging handler 206 can activate a camera, a microphone, or other function that allows the user to capture content to include in a message.

Additionally, the context analyzer 208 can analyze the messages sent from and received by the messaging application 108 for one or more characteristics of user input. In particular, the context analyzer 208 can identify characteristics associated with inputted text to allow the messaging application 108 to predict an emotion of the sender in connection with the messages. For example, the context analyzer 208 can identify characteristics of an input of a user of the client device 200 for use in predicting how the user is feeling or other contextual information associated with the user at the time of composing the message. As described herein, the characteristics can correspond to a keyboard input, including, but not limited to, a typing speed of the keyboard input and/or a touch pressure of the keyboard input (e.g., how hard the user presses each key). Additionally, or alternatively, the characteristics can include other information associated with the keyboard input such as content of the message or information received from one or more other components of the client device 200.

The context analyzer 208 can provide the context information to other components on the messaging application 108 and/or to the server device(s) 106 for providing to other users in a communication thread with the sender. For example, the context analyzer 208 can provide the context information to the user interface manager 202 for presenting the messages in the user interface in a way that allows users participating in the communication thread to better understand the messages. To illustrate, the context analyzer 208 can predict an emotion of the user based on the input by the user at the client device 200 and communicate the predicted emotion to the user interface manager 202.

The user interface manager 202 can use the context information (e.g., the predicted emotion) from the context analyzer 208 to format the message in the user interface. Specifically, the user interface manager 202 (or another component) can receive the predicted emotion and/or context information from the context analyzer 208 and select a formatting of text (e.g., font, size, spacing) for a message based on the predicted emotion. The user interface manager 202 can then format the message within the user interface of the messaging application 108 in accordance with the selected formatting of the text.

The messaging application 108 can further include a location detector 210. The location detector 210 can access or identify a location of the client device 200 based on GPS information from the client device 200, cell tower triangulation, WIFI received signal strength indication, WIFI wireless fingerprinting, radio-frequency identification, near-field communication, by analyzing messages, or based on data from other sources. The location detector 210 can then provide the location of the client device 200 to the context analyzer 208 and/or the server device(s) 106. Additionally, the location detector 210 can receive indications of the location of other client devices from the server device(s) 106 and provide them to the context analyzer 208.

The context analyzer 208 can use the location of the client device 200 to determine additional context information. For example, the context analyzer 208 can determine how the sender is feeling based on the current location of the client device 200. In particular, the context analyzer 208 can determine that the location of the client device 200 corresponds to a known location, and can use the known location in conjunction with other context information to predict the emotion of the user.

The messaging application 108 can also include an acceleration detector 212. The acceleration detector 212 can access or identify movement of the client device 200 based on acceleration information from the client device 200. For example, the acceleration detector 212 may access acceleration information/data from an accelerometer or other movement sensor of the client device 200 and use the acceleration information to determine various movements of the client device 200. The acceleration detector 212 can provide the acceleration information to the context analyzer 208 and/or the server device(s) 106 for use in augmenting text messages with context information.

As discussed above, the client device 200 can include a data storage manager 214, as illustrated in FIG. 2. The data storage manager 214 can maintain message data representative of data used in connection with composing, sending, and receiving messages between a user and one or more other users. Specifically, the data storage manager 214 can store information used by one or more of the components in the message system 100 to facilitate the performance of various operations associated with text message augmentation. In one embodiment as shown in FIG. 2, the data storage manager 214 maintains input text 216, context information, and user profile information.

The data storage manager 214 may also store message data including message logs, contact lists, content, past communications, and other similar types of data that the messaging application 108 can use in connection with providing the ability for users to communicate using the messaging application 108. The data storage manager 214 can store any additional or alternative information corresponding to the operation of the message system 100 and any particular implementation thereof. The data storage manager 214 may communicate with any component within the message system 100 to obtain information for augmenting messages within the messaging application 108. In one embodiment, the data storage manager 214 may be maintained at one or more additional, or alternative, devices within the message system 100, such as on the server device(s) 106.

In one or more embodiments, the data storage manager 214 can store input text 216 that includes any text input by the user in connection with a message. In particular, the input text 216 can include text received from the user input detector 204 in response to a user of the client device 200 interacting with a keyboard of the client device 200. For example, as a user touches a keyboard on a touchscreen of the client device 200, the user input detector 204 can identify characters corresponding to keys or visual elements that the user touches. The user input detector 204 can provide the identified characters to the data storage manager 214 for storing according to the order in which the user has entered the identified characters for use in performing one or more operations of augmenting the message.

In one or more implementations, the data storage manager 214 may maintain context information associated with a message. The context information can be information that describes a context of the message, such as information associated with a message other than the specific characters in the input text 216. For example, the context information can include, but is not limited to, location information, acceleration information, typing speed information, and/or touch pressure information obtain in conjunction with the input text 216 of the message. The data storage manager 214 can provide the context information to one or more components with the input text 216 to predict an emotion of a sender of a message for augmenting the message in accordance with the predicted emotion.

The data storage manager 214 can also store user profile information associated with the user. Specifically, the data storage manager 214 can store user profile information for use in determining whether and how to augment messages based on one or more user preferences or settings associated with the user. For example, the user interface manager 202 may use the user profile information to determine whether the user has preferences directed to one or more types of message augmentations or to whether the user interface manager 202 augments messages in conversations with specific users.

To illustrate, the user profile information can include a preference that allows the user interface manager 202 to augment the text messages in accordance with one or more emotions, but not in accordance with one or more other emotions. In another example, the user profile information can include a preference that allows the user interface manager 202 to augment messages in conversations with one or more users, but not in conversations with one or more other users. In another example, the user profile information may include a preference that the user has opted out of any message augmentation.

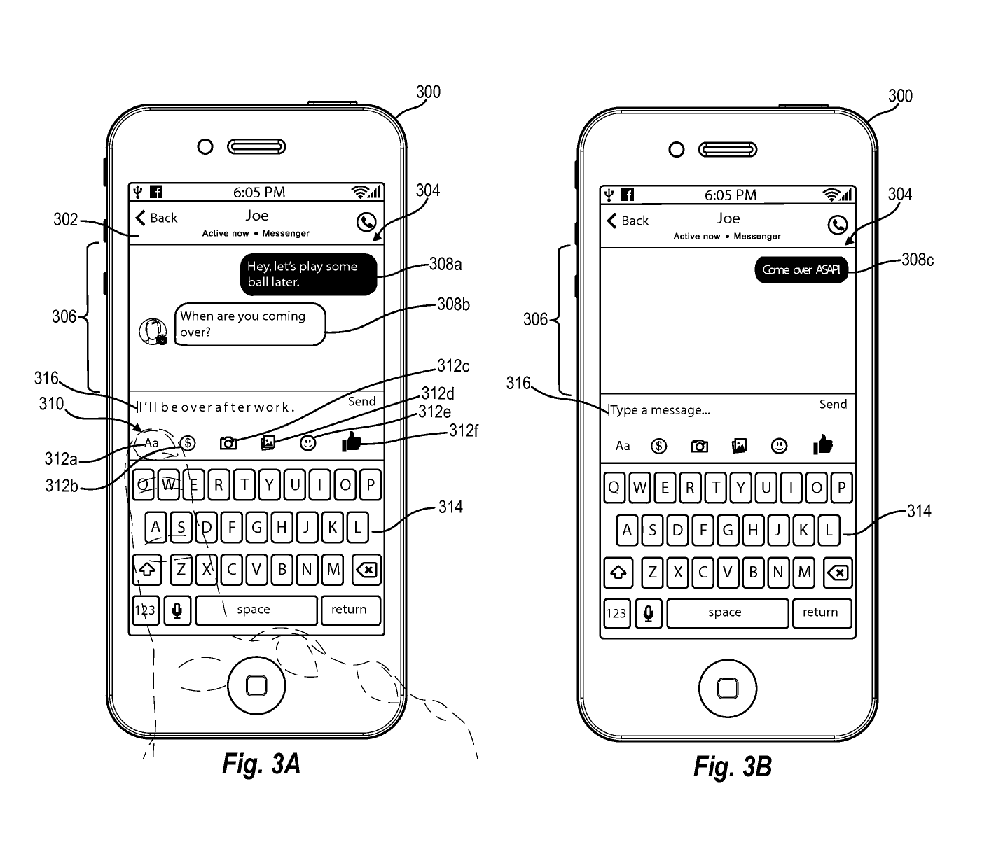

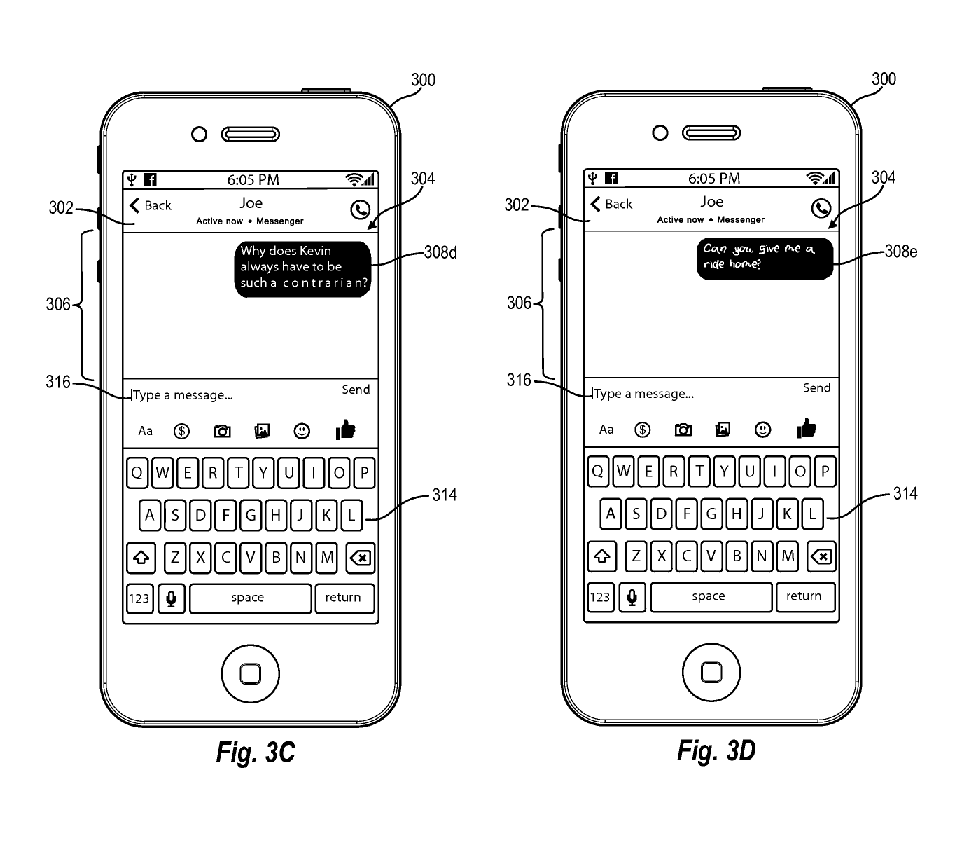

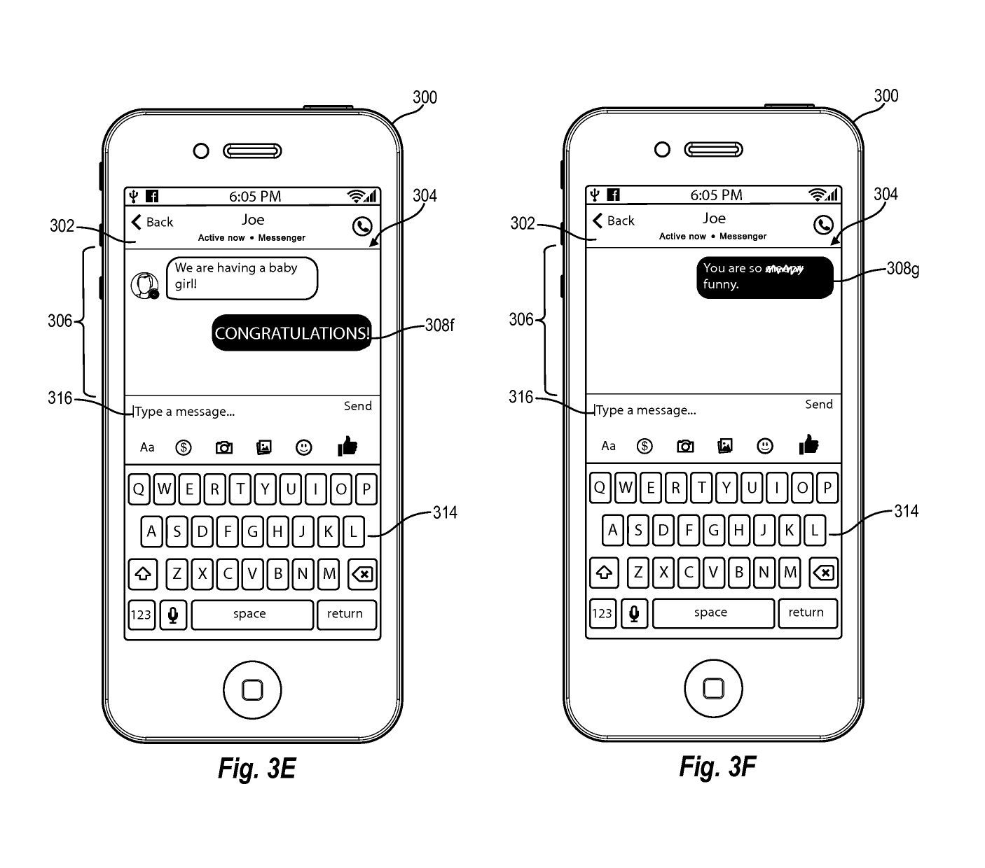

As discussed, the systems and components discussed above with reference to FIGS. 1-2 can allow a message system 100 to augment text messages between users with emotion or other context information. Specifically, the message system 100 can format text messages according to the emotion information to depict the emotion using an appearance of the text. As will be described in more detail below, the components of the message system 100 as described with regard to FIGS. 1-2 can provide, alone and/or in combination with the other components, one or more graphical user interfaces. The messaging system 100 allows a user to interact with a collection of display elements for a variety of purposes. In particular, FIGS. 3A-3F and the description that follows illustrate various example embodiments of the user interfaces and features for exchanging messages between a sender and a recipient in, for example, messaging application 108.

For example, FIGS. 3A-3F illustrate various views of GUIs provided by the messaging application 108 to facilitate electronic messaging. In some examples, a client device 200 can implement some or all of the components of the message system 100, as described with reference to FIG. 2. For example, FIG. 3A illustrates a client device 300 that is a handheld device, such as a mobile phone device (e.g., a smartphone). As used herein, the term “handheld device” refers to a device sized and configured to be held/operated in a single hand of a user. In additional or alternative examples, however, any other suitable computing device, such as, but not limited to, a tablet device, a handheld device, larger wireless devices, laptop or desktop computer, a personal-digital assistant device, or other suitable computing device can perform one or more of the processes and/or operations described herein.

The client device 300 can include any of the features and components described below in reference to the computing device 500 of FIG. 5. As illustrated in FIG. 3A, the client device 300 includes a touchscreen 302 that can display or provide user interfaces and by way of which the client device 300 receives and/or detects user input. As used herein, a “touchscreen display” refers to the display of a touchscreen device. In one or more embodiments, a touchscreen device may be a client device 300 with at least one surface upon which a user may perform touch gestures (e.g., a laptop, a tablet computer, a personal digital assistant, a media player, a mobile phone). Additionally or alternatively, the client device 300 may include any other suitable input device, such as a touch pad or those described below in reference to FIG. 5.

As noted previously, the message system 100 can include a system for electronic messaging (e.g., a messaging application 108 such as MESSENGER). FIG. 3A illustrates a messaging graphical user interface (or “messaging interface”) 304 on the touchscreen 302 of the client device 300. The messaging interface 304 can include messages involving two or more users of the message system 100. For example, the messaging interface 304 can include a messaging thread 306 between two or more users of the message system 100, including a history of electronic messages 308a, 308b exchanged between the users.

The message system 100 can provide a variety of electronic communication characteristics to help a user distinguish between electronic communications in the messaging thread 306. For example, as illustrated in FIG. 3A, the messaging interface 304 displays the electronic message 308a sent by the user of the client device 300 pointed toward one side (i.e., the right side) of the messaging interface 304. On the other hand, the messaging interface 304 can display the electronic messages 308b received from other users pointed toward the opposite side (i.e., the left side) of the messaging interface 304. In one or more embodiments, the positioning and orientation of the electronic messages 308a, 308b provides a clear indicator to a user of the client device 300 of the origin of the various electronic communications displayed within the messaging interface 304.

Another characteristic of the messaging interface 304 that helps a user distinguish electronic communications may be a color of the electronic communications. For example, as shown in FIG. 3A, the messaging interface 304 displays sent electronic messages 308a in a first color and received electronic messages 308b in a second color. In one or more embodiments, the first and second colors may be black and white, respectively, with an inverted typeface color. In an alternative embodiment, the messaging interface 304 may display the electronic messages 308a, 308b with white backgrounds and different colored outlines.

The messaging interface 304 can also include a message input control toolbar 310. In one or more embodiments, the message input control toolbar 310 includes a variety of selectable message input controls that provide a user with various message input options or other options. For example, the message input control toolbar 310 include a text input control 312a, a payment control 312b, a camera viewfinder input control 312c, a multimedia input control 312d, a symbol input control 312e, and a like indicator control 312f. In one or more alternative embodiments, the message input control toolbar 310 may provide the input controls in a different order, may provide other input controls not displayed in FIG. 3A, or may omit one or more of the input controls shown in FIG. 3A.

As will be described below in greater detail, a user may interact with any of the input controls in order to compose and send different types of electronic communications. For example, if a user interacts with the text input control 312a, the messaging interface 304 may provide a touchscreen display keyboard 314 in a portion of the messaging interface 304 that the user may utilize to compose a text message in an input field 316. Similarly, if a user interacts with the multimedia input control 312d, the messaging interface 304 may include a multimedia content item display area (e.g., for displaying digital photographs, digital videos, etc.). Likewise, if a user interacts with the camera viewfinder input control 312c, the messaging interface 304 may include a digital camera interface that the user may utilize to capture, send, and add a digital photograph or digital video to the messaging thread 306. If a user interacts with the payment control 312b, the messaging interface 304 can include a payment interface by which the user can input and send a payment to another user within the messaging thread 306.

As mentioned, a user may interact with any of the message input controls in order to compose and send a message to one or more co-users via the message system 100. For example, FIG. 3A illustrates a user's finger interacting with the text input control 312a. The messaging application 108 can detect interactions (e.g., a tap touch gesture) of the user's finger or other input device with the text input control 312a and display the touchscreen display keyboard 314 within a portion of the messaging interface 304. To illustrate, the messaging interface 304 can include the messaging thread 306 in a first portion (i.e., the upper portion), and the keyboard 314 in a second portion (i.e., the lower portion). In alternative embodiments, the messaging interface 304 can include the messaging thread 306 and the keyboard 314 in another arrangement other than a vertical arrangement.

In one or more embodiments, when the user begins typing within the messaging interface 304 by interacting with the keyboard 314, the messaging interface 304 can display the corresponding characters in an input field 316 above the message input control toolbar 310. As illustrated in FIG. 3A, the sender (“Brad”) of the client device 300 exchanges messages with the recipient (“Joe”) participating in the conversation in the messaging thread 306. For example, after the sender receives a message from the recipient (“When are you coming over?”), the sender can respond with a message by tapping on the input field 316 or on the text input control 312a and tapping on elements in the keyboard 314 to enter characters. Additionally, the messaging interface 304 can populate the typed characters into the input field 316 in real-time as the sender taps the corresponding elements. To illustrate, the messaging interface 304 can display the message, “I'll be over after work” in the input field 316 as the sender enters each character.

As mentioned previously, the message system 100 can identify one or more characteristics of the input from the sender for use in predicting an emotion of the sender. For example, the message system 100 can identify a typing speed of the keyboard input from the sender in connection with the entered characters. The message system 100 can use the identified typing speed to predict an emotion or mood of the sender in connection with the message. Specifically, the message system 100 can predict an emotion that the sender is attempting to convey or project with the message to the recipient.

To illustrate, a slow typing speed can indicate that the sender may have a certain emotion while typing the message. In contrast, a fast typing speed can indicate that the sender may have a different emotion while typing the message. For example, if the sender types slowly, the message system 100 can determine that the sender feels that the message is not urgent. In alternative embodiments, the message system 100 can predict other emotions based on the typing speed associated with the keyboard input, such as whether the sender is interested in the conversation or whether the sender is in a hurry.

In one or more embodiments, to accurately predict the emotion of the sender, the message system 100 can analyze the one or more characteristics of the keyboard input and assign a value to the characteristics to predict the emotion of the sender. The message system 100 can compare the value of the characteristics to a predetermined threshold. The message system 100 can then predict the emotion of the sender based on the comparison of the characteristic to the predetermined threshold. For example, the message system 100 can determine that the sender has a first emotion (e.g., the sender feels that the message is urgent or the sender is in a hurry) if the value of the typing speed is above a predetermined typing speed, and that the sender has a second emotion (e.g., the sender does not feel that the message is urgent or the sender is not in a hurry) if the value of the typing speed is below the predetermined typing speed.

According to one or more additional or alternative embodiments, the message system 100 can compare the one or more characteristics to a plurality of predetermined thresholds. In particular, the message system 100 can determine whether a value assigned to the characteristics is above or below each of the predetermined thresholds to identify a specific value range to which the value corresponds. For example, the message system 100 can predict an emotion of the sender based on whether the value of the characteristics of the keyboard input falls within a range of values corresponding to the emotion (e.g., above a first threshold and below a second threshold). Thus, the message system 100 can predict one of a plurality of emotions based on one or more characteristics of the keyboard input.

In one or more embodiments, the message system 100 can embed emotion information into the message by formatting the text of the message in accordance with the predicted emotion. Specifically, the message system 100 can format the message to allow a recipient of the message to infer the emotion of the sender based on a formatting of the message. For example, the message system 100 can format the message by setting the appearance of the text to indicate the predicted emotion. Additionally, or alternatively, the message system 100 can set the formatting of the message by modifying a speech bubble or other background of the text to indicate the predicted emotion. In another alternative embodiment, the message system 100 can provide additional information with the message to explicitly or implicitly indicate the predicted emotion.

To illustrate, one or more embodiments of the message system 100 can set or modify the text in response to determining that the sender is typing slowly. For example, the message system 100 can set a spacing (or kerning) of the text to reflect the predicted emotion that the sender is not in a hurry, as illustrated in FIG. 3A. Alternatively, the message system 100 can format the text by adjusting the leading of the text, spaces between words, or other spacing adjustments that can imply an urgency (or lack thereof) of the sender.

To identify the predicted emotion, one or more embodiments of the message system 100 can predict the emotion from a plurality of possible emotions. For example, the message system 100 can access a database that includes mappings of the possible emotions to characteristics of a keyboard input to determine which emotion corresponds to the identified characteristics. To illustrate, after identifying the typing speed of the keyboard input, the message system 100 can access the database to determine which emotion corresponds to a slow typing speed. The database can include a lookup table or other storage medium that allows the message system 100 to correlate emotions with one or more characteristics of a keyboard input. In one or more implementations, the message system 100 can populate the database based on research and machine learning associated with emotions and user interactions with the message system 100.

According to one or more embodiments, the message system 100 can apply the formatting changes as the sender types the message. In particular, the message system 100 can set the kerning of the text (or other formatting settings) as the sender types the message into the input field 316. Thus, the sender can see the formatting as the sender is typing the message into the input field 316 and prior to sending the message to the recipient. Alternatively, the message system 100 can apply the formatting to the message after the sender has sent the message, such that the message formatting only applies to the message at the time the message is visible within the messaging thread 306.

In one or more embodiments, the message system 100 can associate the predicted emotion with the message by embedding the predicted emotion into metadata associated with the message. For example, as mentioned previously, the message system 100 can predict the emotion using a database of possible emotions. Once an emotion is identified, the message system 100 can store emotion information for the predicted emotion in metadata for the message, and the messaging application 108 on each client device 300 can read the embedded emotion information in the message and display the message according to each user's preferences. To illustrate, the message system 100 can determine that a user has opted out of displaying emotion information and can display a message with default formatting for the message. Alternatively, the message system 100 can determine that a user has opted into displaying emotion information and can display the message with formatting based on the embedded emotion information.

In one or more embodiments, the message system 100 can set the formatting of messages based on user preferences associated with the sender and/or one or more recipients. For example, the message system 100 can set the formatting of a message in response to determining that the message is intended for a specific recipient or group of recipients. To illustrate, the message system 100 can determine that the sender has set a user preference to apply a formal formatting to the message for one or more specified users (e.g., by adding or correcting punctuation or other syntax errors, or by setting the font to a formal font). When the sender sends a message to the one or more specified users, the message system 100 can display the message without emotion information. When the sender sends a message to one or more other users, the message system 100 can display the message with emotion information.

FIG. 3B illustrates another embodiment of the messaging interface 304 including a messaging thread 306 between the sender and the recipient. As shown, the sender has sent a message 308c to the recipient (“Come over ASAP”). The message system 100 can determine that the typing speed of the keyboard input by the sender is above a predetermined threshold, and can set the formatting of the text in the message accordingly. For example, the message system 100 can set a spacing of the text so that the characters are closer together, indicating that the sender was in a hurry. In one or more embodiments, the message system 100 can set the spacing of the text so that one or more of the characters in the text are overlapping.

According to various embodiments, the message system 100 can set the formatting of the text in accordance with a range of continuous values corresponding to the characteristics of the keyboard input. For example, when formatting a spacing or kerning of the text based on the typing speed of the keyboard input, the message system 100 can format the spacing based on a range of continuous values of the typing speed. Thus, the message system 100 can set the spacing of the text to a value in a range of continuous spacing values corresponding to the range of continuous values of the typing speed.

Alternatively, the message system 100 can set the formatting of the text in accordance with discrete values corresponding to the characteristics of the keyboard input. For example, when formatting the spacing of the text based on the typing speed of the keyboard input, the message system 100 can format the spacing based on a range of discrete values of the typing speed (20 words per minute (wpm), 40 wpm, 60 wpm, etc.). To illustrate, the formatting of the text can be at a first value for typing speeds from 0 to 20 wpm, a second value for typing speeds from 20 to 40, a third value for typing speeds from 40 to 60, etc.

In one or more additional embodiments, the message system 100 can use more than one characteristic of the keyboard input to predict an emotion. Specifically, the message system 100 can determine at least two different characteristics of the keyboard input associated with more than one component of the client device 300 and predict the emotion of the sender based on a combination of the different characteristics. For example, the message system 100 can use the typing speed and content of the keyboard input to predict the emotion of the sender. To illustrate, the message system 100 can determine that the sender is in a hurry in response to determining that the sender is typing quickly and also based on one or more keywords (e.g., in response to determining that the message 308c also includes “ASAP,” as in FIG. 3B) in the keyboard input.

According to one or more embodiments, the message system 100 can apply different weighting to the characteristics to predict the emotion of the sender. For example, the message system 100 can use an algorithm to combine values associated with the different characteristics of the keyboard input into a single characteristic value. To illustrate, the message system 100 can apply a first weight to the typing speed of the keyboard input, a second weight to the content of the message 308c. Alternatively, the message system 100 can apply other combinations of weights to the characteristics, for example, by applying the same weight to more than one characteristic. In one or more implementations, the message system 100 can use more than two characteristics and can apply any weight to each of the characteristics, as may serve a particular embodiment.

In at least some embodiments, the message system 100 can determine a characteristic for the message as a whole. In particular, the message system 100 can determine the characteristic for the whole message 308c for applying a formatting corresponding to the characteristic to the message as a whole. For example, the message system 100 can calculate an average typing speed for the message 308c and set a kerning of all text in the message 308c based on the average typing speed, as shown in FIGS. 3A-3B.

In additional or alternative embodiments, the message system 100 can apply different formatting to different words or characters within a message based on characteristics of the words or characters in the message. Specifically, the message system 100 can apply a first formatting to a first word or group of characters and a second formatting to a second word or group of characters in the same message. For example, the message system 100 can determine that the first word or group of characters has a first typing speed (e.g., by calculating an average typing speed for the first word or group of characters), and the second word has a second typing speed (e.g., by calculating an average typing speed for the second word or group of characters).

To illustrate, FIG. 3C shows a message 308d (“Why does Kevin always have to be such a contrarian?”) containing words with different applied formats. The message system 100 determines that the first group of characters (“Why does Kevin always have to be such a”) has a different typing speed than the second group of characters (“contrarian”). For example, the message system 100 can determine that the average typing speeds of the two groups of characters are significantly different (e.g., the average typing speeds are greater than a threshold difference). The message system 100 can then set the spacing of the first group of characters to a first spacing value, and the spacing of the second group of characters to a second spacing value. By setting the spacing value of the groups differently, the message system 100 can indicate that the sender was more careful or thoughtful when entering a portion of the message 308d.

As previously mentioned, the message system 100 can use location information to predict an emotion of the sender of a message. Specifically, the message system 100 can associate a specific emotion with a location and determine that a client device 300 of the sender is currently at the location based on GPS information from the client device 300. FIG. 3D illustrates the messaging interface 304 with a message 308e that is formatted based at least on the location of the client device 300 of the sender. In particular, the message system 100 determines that the client device 300 of the sender is at a club at the time the sender sends the message 308e (“Can you give me a ride home?”). The message system 100 can format the text of the message 308e, for example, by setting the font to appear as if the sender was writing the message 308e while tired.

Additionally, or alternatively, the message system 100 can associate a specific emotion with a specific time frame in addition to the location information. For example, the message system 100 can predict that the sender is tired if the sender sends a message from a club within a certain time range (e.g., between 12:00 and 6:00 AM). Thus, the message system 100 can format the message with text indicating that the sender is tired if the sender sends the message from the club within the specified time frame, but not if the sender sends the message outside the specified time frame. Alternatively, the message system 100 can predict an emotion based solely on a specific time frame. For example, the message system 100 can predict that a sender of a message is tired if a message is sent late at night and format the message accordingly.

In one or more embodiments, the message system 100 can predict an emotion based on the touch pressure on the keyboard 314. In particular, the message system 100 can detect the pressure that the sender applies to an element on the keyboard 314 (e.g., a key on a physical keyboard or a screen element on a touch keyboard) to enter a corresponding character into the input field 316 for a message. Based on the touch pressure for one or more characters, the message system 100 can predict an emotion associated with the message. For example, if the sender is pressing hard on the elements of the keyboard 314, the message system 100 can predict that the sender is excited, angry, etc. In contrast, if the sender is pressing lightly on the elements of the keyboard 314, the message system 100 can predict that the sender is calm.

In response to predicting the emotion based on the touch pressure, the message system 100 can format the text of the message by changing a size of the message. For example, as shown in FIG. 3E, the message system 100 can increase a size of the text in a message 308f (“CONGRATULATIONS”) above a default text size in response to determining that the touch pressure is greater than a predetermined threshold. Alternatively, the message system 100 can decrease the size of the text below the default text size in response to determining that the touch pressure is less than a predetermined threshold. As with the typing speed, the message system 100 can set the size of the font according to a continuous or a discrete scale, as may serve a particular embodiment. In one or more alternative embodiments, the message system 100 can automatically capitalize the text or change the text to lowercase in accordance with the touch pressure of the keyboard input.

According to one or more additional, or alternative, embodiments, the message system 100 can analyze the keyboard input as the sender enters characters into the input field 316 to predict an emotion of the sender by determining that the sender interacts with a character or word previously entered into the input field 316. For example, FIG. 3F illustrates an embodiment of the messaging interface 304 including a message 308g with formatting indicating the sender has interacted with a word previously entered into the input field 316. Specifically, the messaging application 108 detects that the sender deleted a word (“creepy”) and replaced it with another word (“funny”). The messaging application 108 then formats the message 308g by “scratching out” the deleted word to indicate that the user deleted the word. By detecting the user interactions and automatically formatting the message in a way that illustrates the user interactions to a recipient, the message system 100 can embed an emotion of the sender (e.g., that the sender is being sarcastic, careful or precise) into the message based on the deleted word and the word that replaced the deleted word.

According to one or more additional, or alternative, embodiments, the message system 100 can use other input data from one or more sensors of the client device 300 (e.g., a location sensor, a pressure sensor, a microphone sensor, a motion sensor, or a camera sensor), and use the received input data to further predict the user's context and/or emotion for a message. For example, the message system 100 can use input from a microphone, a camera, or one or more external devices connected to the client device 300 to predict an emotion of the sender. To illustrate, the message system 100 can use a microphone input volume to determine that the sender is dancing or enjoying himself while at a party. The message system 100 can then format the text to move as if dancing, or to be harder to see (e.g., by graying the text out) indicating that the sender is in a location that is hard to hear. In another example, the message system 100 can use camera input to read an expression on the sender's face or to detect the ambient light to help predict an emotion of the user in conjunction with the keyboard input.

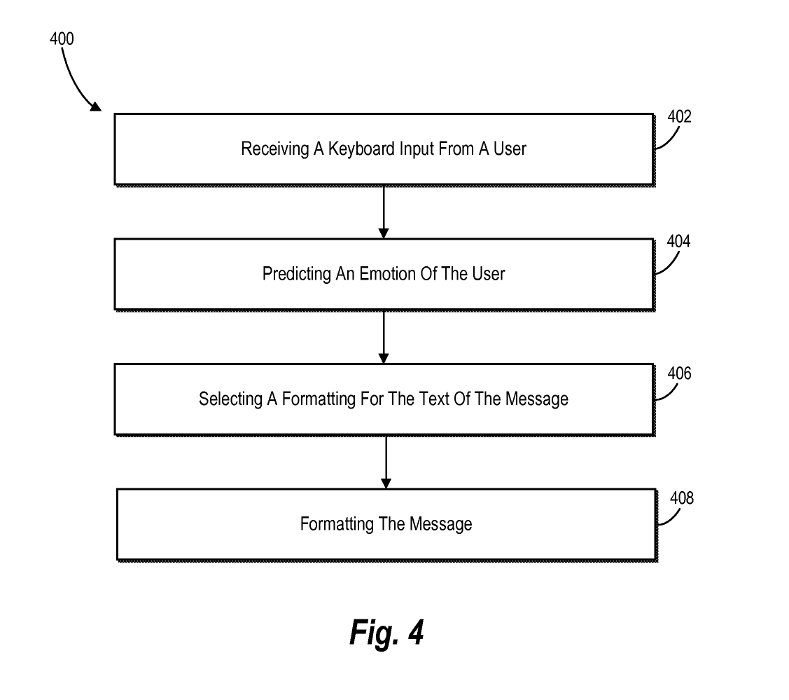

FIGS. 1-3F, the corresponding text, and the examples, provide a number of different systems and devices for sending and receiving messages using a messaging application. In addition to the foregoing, embodiments can be described in terms of flowcharts comprising acts and steps in a method for accomplishing a particular result. For example, FIG. 4 illustrates a flowchart of exemplary methods in accordance with one or more embodiments.

FIG. 4 illustrates a flowchart of a method 400 of augmenting messages with emotion information. The method 400 includes an act 402 of receiving a keyboard input from a user. For example, act 402 involves receiving a keyboard input from a user to input text in a message within a messaging application 108. To illustrate, act 402 can involve detecting the keyboard input at a client device 102a, 102b, 200, or 300 of the user. In one or more instances, act 402 can involve receiving the keyboard input as the user types the message. In alternative examples, act 402 can involve receiving the keyboard input after the user selects to send the message to a recipient.

The method 400 also includes an act 404 of predicting an emotion of the user. For example, act 404 involves predicting an emotion of the user based on one or more characteristics of the keyboard input. Act 404 can also involve analyzing the keyboard input to determine the one or more characteristics, accessing a table of mappings between keyboard input characteristics and emotions, and predicting the emotion based on the table of mappings.

The method 400 can additionally, or alternatively, include receiving information from one or more sensors of the client device 102a, 102b, 200, or 300. For example, the method 400 can include receiving information from at least one of a location sensor, a pressure sensor, a microphone sensor, or a camera sensor of the client device 102a, 102b, 300. The method 400 can further include identifying one or more characteristics of the information from the one or more sensors of the client device 102a, 102b, 300.

As mentioned above, the one or more characteristics of the keyboard input can include a typing speed of the keyboard input. Additionally, act 404 can involve determining that the typing speed is above a predetermined typing speed, and decreasing a spacing between characters in the text in response to the typing speed being above the predetermined typing speed. Act 404 can also involve determining that the typing speed is below a predetermined typing speed, and increasing a spacing between characters in the text in response to the typing speed being below the predetermined typing speed. Additionally or alternatively, the one or more characteristics of the keyboard input can include one or more of a touch pressure of the keyboard input or movement information from an accelerometer of a mobile device of the user.

As part of act 404, or as an additional act, the method 400 can include an act of identifying one or more words in the text of the message, and predicting the emotion based on the one or more characteristics of the keyboard input and the one or more words in the text of the message (e.g., using natural language processing).

As part of act 404, or as an additional act, the method 400 can include an act of identifying a location of a client device 102a, 102b, 200, or 300 of the user, and predicting the emotion based on the one or more characteristics of the keyboard input and the location of the client device 102a, 102b, 300 of the user. Additionally, the method 400 can include predicting the emotion based on the one or more characteristics of the one or more sensors of the client device 102a, 102b, 200, or 300.

Furthermore, the method 400 includes an act 406 of selecting a formatting for the text of the message. For example, act 406 involves selecting a formatting for the text of the message based on the predicted emotion of the user. Act 406 can further involve selecting a font of the text in accordance with the predicted emotion. To illustrate, act 406 can involve selecting the font of the text including at least one of a font size or a font shape.

Additionally, the method 400 includes an act 408 of formatting the message. For example, act 408 involves formatting the message within the messaging application 108 in accordance with the selected formatting of the text. To illustrate, act 408 can involve displaying the message with text formatted according to the selected formatting within a messaging thread 306 of the messaging application 108.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 5 illustrates a block diagram of exemplary computing device 500 that may be configured to perform one or more of the processes described above. One will appreciate that one or more computing devices such as the computing device 500 may implement the message system 100. As shown by FIG. 5, the computing device 500 can comprise a processor 502, a memory 504, a storage device 506, an I/O interface 508, and a communication interface 510, which may be communicatively coupled by way of a communication infrastructure 512. While an exemplary computing device 500 is shown in FIG. 5, the components illustrated in FIG. 5 are not intended to be limiting. Additional or alternative components may be used in other embodiments. Furthermore, in certain embodiments, the computing device 500 can include fewer components than those shown in FIG. 5. Components of the computing device 500 shown in FIG. 5 will now be described in additional detail.

In one or more embodiments, the processor 502 includes hardware for executing instructions, such as those making up a computer program. As an example and not by way of limitation, to execute instructions, the processor 502 may retrieve (or fetch) the instructions from an internal register, an internal cache, the memory 504, or the storage device 506 and decode and execute them. In one or more embodiments, the processor 502 may include one or more internal caches for data, instructions, or addresses. As an example and not by way of limitation, the processor 502 may include one or more instruction caches, one or more data caches, and one or more translation lookaside buffers (TLBs). Instructions in the instruction caches may be copies of instructions in the memory 504 or the storage 706.

The memory 504 may be used for storing data, metadata, and programs for execution by the processor(s). The memory 504 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 504 may be internal or distributed memory.

The storage device 506 includes storage for storing data or instructions. As an example and not by way of limitation, storage device 506 can comprise a non-transitory storage medium described above. The storage device 506 may include a hard disk drive (HDD), a floppy disk drive, flash memory, an optical disc, a magneto-optical disc, magnetic tape, or a Universal Serial Bus (USB) drive or a combination of two or more of these. The storage device 506 may include removable or non-removable (or fixed) media, where appropriate. The storage device 506 may be internal or external to the computing device 500. In one or more embodiments, the storage device 506 is non-volatile, solid-state memory. In other embodiments, the storage device 506 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 508 allows a user to provide input to, receive output from, and otherwise transfer data to and receive data from computing device 500. The I/O interface 508 may include a mouse, a keypad or a keyboard, a touchscreen, a camera, an optical scanner, network interface, modem, other known I/O devices or a combination of such I/O interfaces. The I/O interface 508 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 508 is configured to provide graphical data to a display for presentation to a user. The graphical data may be representative of one or more graphical user interfaces and/or any other graphical content as may serve a particular implementation.

The communication interface 510 can include hardware, software, or both. In any event, the communication interface 510 can provide one or more interfaces for communication (such as, for example, packet-based communication) between the computing device 500 and one or more other computing devices or networks. As an example and not by way of limitation, the communication interface 510 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 510 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 510 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 510 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 512 may include hardware, software, or both that couples components of the computing device 500 to each other. As an example and not by way of limitation, the communication infrastructure 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the system 100 can comprise a social-networking system. A social-networking system may enable its users (such as persons or organizations) to interact with the system and with each other. As mentioned above, the system 100 can comprise a social-networking system. A social-networking system may enable its users (such as persons or organizations) to interact with the system and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, on-line calendars and event organization, messaging, games, or advertisements) to facilitate social interaction between or among users. Also, the social-networking system may allow users to post photographs and other multimedia content items to a user's profile page (typically known as “wall posts” or “timeline posts”) or in a photo album, both of which may be accessible to other users of the social-networking system depending upon the user's configured privacy settings.

FIG. 6 illustrates an example network environment 600 of a social-networking system. Network environment 600 includes a client system 606, a social-networking system 602, and a third-party system 608 connected to each other by a network 604. Although FIG. 6 illustrates a particular arrangement of client system 606, social-networking system 602, third-party system 608, and network 604, this disclosure contemplates any suitable arrangement of client system 606, social-networking system 602, third-party system 608, and network 604. As an example and not by way of limitation, two or more of client system 606, social-networking system 602, and third-party system 608 may be connected to each other directly, bypassing network 604. As another example, two or more of client system 606, social-networking system 602, and third-party system 608 may be physically or logically co-located with each other in whole or in part. Moreover, although FIG. 6 illustrates a particular number of client systems 606, social-networking systems 602, third-party systems 608, and networks 604, this disclosure contemplates any suitable number of client systems 606, social-networking systems 602, third-party systems 608, and networks 604. As an example and not by way of limitation, network environment 600 may include multiple client system 606, social-networking systems 602, third-party systems 608, and networks 604.

This disclosure contemplates any suitable network 604. As an example and not by way of limitation, one or more portions of network 604 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 604 may include one or more networks 604.

Links may connect client system 606, social-networking system 602, and third-party system 608 to communication network 604 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 600. One or more first links may differ in one or more respects from one or more second links.

In particular embodiments, client system 606 may be an electronic device including hardware, software, or embedded logic components or a combination of two or more such components and capable of carrying out the appropriate functionalities implemented or supported by client system 606. As an example and not by way of limitation, a client system 606 may include any of the computing devices discussed above in relation to FIG. 5. A client system 606 may enable a network user at client system 606 to access network 604. A client system 606 may enable its user to communicate with other users at other client systems 606.

In particular embodiments, client system 606 may include a web browser 932, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 606 may enter a Uniform Resource Locator (URL) or other address directing the web browser to a particular server (such as server, or a server associated with a third-party system 608), and the web browser may generate a Hyper Text Transfer Protocol (HTTP) request and communicate the HTTP request to server. The server may accept the HTTP request and communicate to client system 606 one or more Hyper Text Markup Language (HTML) files responsive to the HTTP request. Client system 606 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 602 may be a network-addressable computing system that can host an online social network. Social-networking system 602 may generate, store, receive, and send social-networking data, such as, for example, user-profile data, concept-profile data, social-graph information, or other suitable data related to the online social network. Social-networking system 602 may be accessed by the other components of network environment 600 either directly or via network 604. In particular embodiments, social-networking system 602 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, social-networking system 602 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client system 606, a social-networking system 602, or a third-party system 608 to manage, retrieve, modify, add, or delete, the information stored in data store.

In particular embodiments, social-networking system 602 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Social-networking system 602 may provide users of the online social network the ability to communicate and interact with other users. In particular embodiments, users may join the online social network via social-networking system 602 and then add connections (e.g., relationships) to a number of other users of social-networking system 602 whom they want to be connected to. Herein, the term “friend” may refer to any other user of social-networking system 602 with whom a user has formed a connection, association, or relationship via social-networking system 602.

In particular embodiments, social-networking system 602 may provide users with the ability to take actions on various types of items or objects, supported by social-networking system 602. As an example and not by way of limitation, the items and objects may include groups or social networks to which users of social-networking system 602 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 602 or by an external system of third-party system 608, which is separate from social-networking system 602 and coupled to social-networking system 602 via a network 604.

In particular embodiments, social-networking system 602 may be capable of linking a variety of entities. As an example and not by way of limitation, social-networking system 602 may enable users to interact with each other as well as receive content from third-party systems 608 or other entities, or to allow users to interact with these entities through an application programming interfaces (API) or other communication channels.

In particular embodiments, a third-party system 608 may include one or more types of servers, one or more data stores, one or more interfaces, including but not limited to APIs, one or more web services, one or more content sources, one or more networks, or any other suitable components, e.g., that servers may communicate with. A third-party system 608 may be operated by a different entity from an entity operating social-networking system 602. In particular embodiments, however, social-networking system 602 and third-party systems 608 may operate in conjunction with each other to provide social-networking services to users of social-networking system 602 or third-party systems 608. In this sense, social-networking system 602 may provide a platform, or backbone, which other systems, such as third-party systems 608, may use to provide social-networking services and functionality to users across the Internet.

In particular embodiments, a third-party system 608 may include a third-party content object provider. A third-party content object provider may include one or more sources of content objects, which may be communicated to a client system 606. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 602 also includes user-generated content objects, which may enhance a user's interactions with social-networking system 602. User-generated content may include anything a user can add, upload, send, or “post” to social-networking system 602. As an example and not by way of limitation, a user communicates posts to social-networking system 602 from a client system 606. Posts may include data such as status updates or other textual data, location information, photos, videos, links, music or other similar data or media. Content may also be added to social-networking system 602 by a third-party through a “communication channel,” such as a newsfeed or stream.

In particular embodiments, social-networking system 602 may include a variety of servers, sub-systems, programs, modules, logs, and data stores. In particular embodiments, social-networking system 602 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 602 may also include suitable components such as network interfaces, security mechanisms, load balancers, failover servers, management-and-network-operations consoles, other suitable components, or any suitable combination thereof. In particular embodiments, social-networking system 602 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 602 to one or more client systems 606 or one or more third-party system 608 via network 604. The web server may include a mail server or other messaging functionality for receiving and routing messages between social-networking system 602 and one or more client systems 606. An API-request server may allow a third-party system 608 to access information from social-networking system 602 by calling one or more APIs. An action logger may be used to receive communications from a web server about a user's actions on or off social-networking system 602. In conjunction with the action log, a third-party-content-object log may be maintained of user exposures to third-party-content objects. A notification controller may provide information regarding content objects to a client system 606. Information may be pushed to a client system 606 as notifications, or information may be pulled from client system 606 responsive to a request received from client system 606. Authorization servers may be used to enforce one or more privacy settings of the users of social-networking system 602. A privacy setting of a user determines how particular information associated with a user can be shared. The authorization server may allow users to opt in to or opt out of having their actions logged by social-networking system 602 or shared with other systems (e.g., third-party system 608), such as, for example, by setting appropriate privacy settings. Third-party-content-object stores may be used to store content objects received from third parties, such as a third-party system 608. Location stores may be used for storing location information received from client systems 606 associated with users. Advertisement-pricing modules may combine social information, the current time, location information, or other suitable information to provide relevant advertisements, in the form of notifications, to a user.

FIG. 7 illustrates example social graph 700. In particular embodiments, social-networking system 602 may store one or more social graphs 700 in one or more data stores. In particular embodiments, social graph 700 may include multiple nodes—which may include multiple user nodes 702 or multiple concept nodes 704—and multiple edges 706 connecting the nodes. Example social graph 700 illustrated in FIG. 7 is shown, for didactic purposes, in a two-dimensional visual map representation. In particular embodiments, a social-networking system 602, client system 606, or third-party system 608 may access social graph 700 and related social-graph information for suitable applications. The nodes and edges of social graph 700 may be stored as data objects, for example, in a data store (such as a social-graph database). Such a data store may include one or more searchable or query able indexes of nodes or edges of social graph 700.

In particular embodiments, a user node 702 may correspond to a user of social-networking system 602. As an example and not by way of limitation, a user may be an individual (human user), an entity (e.g., an enterprise, business, or third-party application), or a group (e.g., of individuals or entities) that interacts or communicates with or over social-networking system 602. In particular embodiments, when a user registers for an account with social-networking system 602, social-networking system 602 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 602. In particular embodiments, a user node 702 may be associated with information provided by a user or information gathered by various systems, including social-networking system 602. As an example and not by way of limitation, a user may provide his or her name, profile picture, contact information, birth date, sex, marital status, family status, employment, education background, preferences, interests, or other demographic information. Each user node of the social graph may have a corresponding web page (typically known as a profile page). In response to a request including a user name, the social-networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

In particular embodiments, a concept node 704 may correspond to a concept. As an example and not by way of limitation, a concept may correspond to a place (such as, for example, a movie theater, restaurant, landmark, or city); a website (such as, for example, a website associated with social-network system 602 or a third-party website associated with a web-application server); an entity (such as, for example, a person, business, group, sports team, or celebrity); a resource (such as, for example, an audio file, video file, digital photo, text file, structured document, or application) which may be located within social-networking system 602 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 704 may be associated with information of a concept provided by a user or information gathered by various systems, including social-networking system 602. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 704 may be associated with one or more data objects corresponding to information associated with concept node 704. In particular embodiments, a concept node 704 may correspond to one or more webpages.

In particular embodiments, a node in social graph 700 may represent or be represented by a webpage (which may be referred to as a “profile page”). Profile pages may be hosted by or accessible to social-networking system 602. Profile pages may also be hosted on third-party websites associated with a third-party server 608. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular embodiments, a concept node 704 may represent a third-party webpage or resource hosted by a third-party system 608. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 606 to send to social-networking system 602 a message indicating the user's action. In response to the message, social-networking system 602 may create an edge (e.g., an “eat” edge) between a user node 702 corresponding to the user and a concept node 704 corresponding to the third-party webpage or resource and store edge 706 in one or more data stores.

In particular embodiments, a pair of nodes in social graph 700 may be connected to each other by one or more edges 706. An edge 706 connecting a pair of nodes may represent a relationship between the pair of nodes. In particular embodiments, an edge 706 may include or represent one or more data objects or attributes corresponding to the relationship between a pair of nodes. As an example and not by way of limitation, a first user may indicate that a second user is a “friend” of the first user. In response to this indication, social-networking system 602 may send a “friend request” to the second user. If the second user confirms the “friend request,” social-networking system 602 may create an edge 706 connecting the first user's user node 702 to the second user's user node 702 in social graph 700 and store edge 706 as social-graph information in one or more of data stores. In the example of FIG. 7, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706.

In particular embodiments, an edge 706 between a user node 702 and a concept node 704 may represent a particular action or activity performed by a user associated with user node 702 toward a concept associated with a concept node 704. As an example and not by way of limitation, as illustrated in FIG. 7, a user may “like,” “attended,” “played,” “listened,” “cooked,” “worked at,” or “watched” a concept, each of which may correspond to a edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 602 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 602 may create a “listened” edge 706 and a “used” edge (as illustrated in FIG. 7) between user nodes 702 corresponding to the user and concept nodes 704 corresponding to the song and application to indicate that the user listened to the song and used the application. Moreover, social-networking system 602 may create a “played” edge 706 (as illustrated in FIG. 7) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 7 between user node 702 for user “E” and concept node 704 for “SPOTIFY”).

In particular embodiments, social-networking system 602 may create an edge 706 between a user node 702 and a concept node 704 in social graph 700. As an example and not by way of limitation, a user viewing a concept-profile page (such as, for example, by using a web browser or a special-purpose application hosted by the user's client system 606) may indicate that he or she likes the concept represented by the concept node 704 by clicking or selecting a “Like” icon, which may cause the user's client system 606 to send to social-networking system 602 a message indicating the user's liking of the concept associated with the concept-profile page. In response to the message, social-networking system 602 may create an edge 706 between user node 702 associated with the user and concept node 704, as illustrated by “like” edge 706 between the user and concept node 704. In particular embodiments, social-networking system 602 may store an edge 706 in one or more data stores. In particular embodiments, an edge 706 may be automatically formed by social-networking system 602 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social-networking system 602). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 602 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 602) or RSVP (e.g., through social-networking system 602) to an event associated with the advertisement. In addition or as an alternative, an advertisement may include social-networking-system context directed to the user. As an example and not by way of limitation, an advertisement may display information about a friend of the user within social-networking system 602 who has taken an action associated with the subject matter of the advertisement.

In particular embodiments, social-networking system 602 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 608 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 602 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 602 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 602 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 602 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 602 may calculate a coefficient based on a user's actions. Social-networking system 602 may monitor such actions on the online social network, on a third-party system 608, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social-networking system 602 may calculate a coefficient based on the user's actions with particular types of content. The content may be associated with the online social network, a third-party system 608, or another suitable system. The content may include users, profile pages, posts, news stories, headlines, instant messages, chat room conversations, emails, advertisements, pictures, video, music, other suitable objects, or any combination thereof. Social-networking system 602 may analyze a user's actions to determine whether one or more of the actions indicate an affinity for subject matter, content, other users, and so forth. As an example and not by way of limitation, if a user may make frequently posts content related to “coffee” or variants thereof, social-networking system 602 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 602 may calculate a coefficient based on the type of relationship between particular objects. Referencing the social graph 700, social-networking system 602 may analyze the number and/or type of edges 706 connecting particular user nodes 702 and concept nodes 704 when calculating a coefficient. As an example and not by way of limitation, user nodes 702 that are connected by a spouse-type edge (representing that the two users are married) may be assigned a higher coefficient than user nodes 702 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social-networking system 602 may determine that the user has a higher coefficient with respect to the first photo than the second photo because having a tagged-in-type relationship with content may be assigned a higher weight and/or rating than having a like-type relationship with content. In particular embodiments, social-networking system 602 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 602 may determine that the first user should also have a relatively high coefficient for the particular object. In particular embodiments, the coefficient may be based on the degree of separation between particular objects. Degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.” The lower coefficient may represent the decreasing likelihood that the first user will share an interest in content objects of the user that is indirectly connected to the first user in the social graph 700. As an example and not by way of limitation, social-graph entities that are closer in the social graph 700 (i.e., fewer degrees of separation) may have a higher coefficient than entities that are further apart in the social graph 700.

In particular embodiments, social-networking system 602 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client system 606 of the user). A first user may be more interested in other users or concepts that are closer to the first user. As an example and not by way of limitation, if a user is one mile from an airport and two miles from a gas station, social-networking system 602 may determine that the user has a higher coefficient for the airport than the gas station based on the proximity of the airport to the user.

In particular embodiments, social-networking system 602 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 602 may provide information that is relevant to user's interests and current circumstances, increasing the likelihood that they will find such information of interest. In particular embodiments, social-networking system 602 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 602 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 602 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 608 (e.g., via an API or other communication channel), or from another suitable system. In response to the request, social-networking system 602 may calculate the coefficient (or access the coefficient information if it has previously been calculated and stored). In particular embodiments, social-networking system 602 may measure an affinity with respect to a particular process. Different processes (both internal and external to the online social network) may request a coefficient for a particular object or set of objects. Social-networking system 602 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/976,027, filed 22 Dec. 2010, U.S. patent application Ser. No. 12/978,265, filed 23 Dec. 2010, and U.S. patent application Ser. No. 13/642,869, field 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 704 corresponding to a particular photo may have a privacy setting specifying that the photo may only be accessed by users tagged in the photo and their friends. In particular embodiments, privacy settings may allow users to opt in or opt out of having their actions logged by social-networking system 602 or shared with other systems (e.g., third-party system 608). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 608, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social-networking system 602 may send a request to the data store for the object. The request may identify the user associated with the request and may only be sent to the user (or a client system 606 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

What is claimed is:

1. A method, comprising:
receiving, by a client device comprising at least one processor, a keyboard input from a user to input text in a message within a messaging application;
predicting, by the at least one processor, an emotion of the user based on one or more characteristics of the keyboard input;
selecting, by the at least one processor, a formatting for the text of the message based on the predicted emotion of the user; and
formatting the message within the messaging application in accordance with the selected formatting.

2. The method as recited in claim 1, wherein predicting the emotion of the user based on one or more characteristics of the keyboard input comprises:
analyzing the keyboard input to determine the one or more characteristics;
accessing a table of mappings between keyboard input characteristics and emotions; and
predicting the emotion based on the table of mappings.

3. The method as recited in claim 1, wherein the one or more characteristics of the keyboard input comprise a typing speed of the keyboard input.

4. The method as recited in claim 3, further comprising:
determining that the typing speed is above a predetermined typing speed; and
decreasing a spacing between characters in the text in response to the typing speed being above the predetermined typing speed.

5. The method as recited in claim 3, further comprising:
determining that the typing speed is below a predetermined typing speed; and
increasing a spacing between characters in the text in response to the typing speed being below the predetermined typing speed.

6. The method as recited in claim 1, wherein the one or more characteristics of the keyboard input comprise one or more of a touch pressure of the keyboard input or accelerometer data of a mobile device of the user.

7. The method as recited in claim 1, further comprising:
identifying one or more words in the text of the message; and
predicting the emotion based on the one or more characteristics of the keyboard input and the one or more words in the text of the message.

8. The method as recited in claim 1, wherein selecting a formatting for the text of the message comprises selecting a font of the text in accordance with the predicted emotion.

9. The method as recited in claim 1, further comprising:
identifying a location of the user; and
predicting the emotion based on the one or more characteristics of the keyboard input and the location of the user.

10. A system comprising:
at least one processor; and
at least one non-transitory computer-readable storage medium storing instructions thereon that, when executed by the at least one processor, cause the system to:
receive a keyboard input from a user to input text in a message within a messaging application;
predict an emotion of the user based on one or more characteristics of the keyboard input;
select a formatting for the text of the message based on the predicted emotion of the user; and
format the message within the messaging application in accordance with the selected formatting of the text.

11. The system as recited in claim 10, further comprising instructions that, when executed by the at least one processor, cause the system to predict the emotion of the user in connection with the message based on one or more characteristics of the keyboard input by:
analyzing the keyboard input to determine the one or more characteristics;
accessing a table of mappings between keyboard input characteristics and emotions; and
predicting the emotion based on the table of mappings.

12. The system as recited in claim 11, wherein the one or more characteristics of the keyboard input comprise a typing speed of the keyboard input.

13. The system as recited in claim 12, further comprising instructions that, when executed by the at least one processor, cause the system to:
determine that the typing speed is above a predetermined typing speed; and
decrease a spacing between characters in the text in response to the typing speed being above the predetermined typing speed.

14. The system as recited in claim 12, further comprising instructions that, when executed by the at least one processor, cause the system to:
determine that the typing speed is below a predetermined typing speed; and
increase a spacing between characters in the text in response to the typing speed being below the predetermined typing speed.

15. The system as recited in claim 12, further comprising instructions that, when executed by the at least one processor, cause the system to:
identify a location of a client device of the user; and
determine the predicted emotion based on the one or more characteristics of the keyboard input and the location of the client device of the user.

16. The method as recited in claim 1, further comprising instructions that, when executed by the at least one processor, cause the system to select a formatting for the text of the message by selecting a font of the text in accordance with the predicted emotion.

17. A non-transitory computer readable medium storing instructions thereon that, when executed by at least one processor, cause the at least one processor to perform steps comprising:
receiving a keyboard input from a user to input text in a message within a messaging application;
predicting an emotion of the user based on one or more characteristics of the keyboard input;
selecting a formatting for the text of the message based on the predicted emotion of the user; and
formatting the message within the messaging application in accordance with the selected formatting of the text.

18. The non-transitory computer readable medium as recited in claim 17, further comprising instructions that, when executed by the at least one processor, cause the at least one processor to predict the emotion of the user in connection with the message based on one or more characteristics of the keyboard input by:
analyzing the keyboard input to determine the one or more characteristics;
accessing a table of mappings between keyboard input characteristics and emotions; and
predicting the emotion based on the table of mappings.

19. The non-transitory computer readable medium as recited in claim 17, further comprising instructions that, when executed by the at least one processor, cause the at least one processor to perform steps comprising:
comparing a typing speed of the keyboard input to a predetermined typing speed;
decreasing a spacing between characters in the text in response to a determination that the typing speed is above the predetermined typing speed; and
increasing a spacing between characters in the text in response to a determination that the typing speed is below the predetermined typing speed.

20. The non-transitory computer readable medium as recited in claim 17, further comprising instructions that, when executed by the at least one processor, cause the at least one processor to perform steps comprising selecting a formatting for the text of the message by selecting a font of the text in accordance with the predicted emotion.
